(19) United States
(12) Patent Application Publication
(10) Pub. No.: US 2018/0036757 A1
(43) Pub. Date: Feb. 8, 2018

(54) THIN FILM SHEET AND PREPARATION METHOD THEREOF

(71) Applicants: BOE TECHNOLOGY GROUP CO., LTD., Beijing (CN); HEFEI BOE OPTOELECTRONICS TECHNOLOGY CO., LTD., Hefei, Anhui (CN)

(72) Inventor: Chunhui Wu, Beijing (CN)

(21) Appl. No.: 15/513,553

(22) PCT Filed: Sep. 23, 2016
(86) PCT No.: PCT/CN2016/099828

§ 371 Date: Mar. 22, 2017

(30) Foreign Application Priority Data
Jan. 4, 2016 (CN) 201610003915.7

(51) Int. Cl. B05B 15/02; C08G 18/42

(52) U.S. Cl. CPC B05B 15/02; C08G 18/42; B05B 1/02

(57) ABSTRACT

The present disclosure provides a thin film sheet and a preparation method thereof. This thin film sheet is used for cleaning a slit-type spray nozzle, and comprises a substrate and a gel layer located on at least one side surface of the substrate, wherein the gel layer is produced from a swelling-type polymeric material. In the process of cleaning a spray nozzle of a coater, the presence of the gel layer allows the contact area between this cleaning sheet and the spray nozzle to be increased; and furthermore, the cleaning effect for the spray nozzle of the coater has been also greatly improved, since microporous structures of the surface of the gel layer can better adsorb dust on the spray nozzle of the coater. Meanwhile, the micro-elasticity of the gel layer can reduce scratches of the spray nozzle caused during cleaning. The thin film sheet of this disclosure improves cleaning effect and reduces the number of used thin film sheets required for cleaning, so as to save the cost, reduce the takt time of cleaning, and increase the production efficiency.

### TECHNICAL FIELD

The present invention relates to the field of display technology, and particularly to a thin film sheet and a preparation method thereof.

### BACKGROUND ART

With the development of techniques in the TFT-LCD field, the coating manner of coatings progresses from the spin coating method to the slit-type coating method, which meets the requirement of large-scale glass substrates and save usage amount of the coating, so as to reduce the cost and improve the production efficiency.

As the slit-type coating method has been commonly used, the cleaning of the spray nozzle in a slit-type coater also becomes an indispensable procedure. In the process of coating, coatings will remain in the spray nozzle, and the portion of the solute in coatings will remain in the spray nozzle by the volatilization of the solvent, which influences the subsequent coating by the coater. Therefore, the spray nozzle part must be cleaned periodically to prevent coating badness caused by the blockage of the spray nozzle of the coater.

Among cleaning apparatuses for spray nozzles of coaters in the prior art, some uses a degumming solvent to dissolve photoresists remaining on the spray nozzle, which is then discharged via a drainage hole; some automatically clean the spray nozzle in a mechanical manner, and thoroughly clean the portion of the spray nozzle which cannot be mechanically cleaned by adding an ultrasonic device; and some introduce a sweeping sheet into a slit spray nozzle by using an auxiliary insertion member to clean the slit spray nozzle. In order to ensure the coating quality of the slit spray nozzle, after the spray nozzle is cleaned by using the cleaning apparatuses described above, it is also required to further perform internal cleaning on the slit-like spray nozzle by using a thin film sheet.

A conventional thin film sheet is formed from a polyurethane or polyamide material and is typically only for disposal use. Also, since the conventional thin film sheet has limited cleaning effect, the spray nozzle can be thoroughly cleaned only if a plurality of thin film sheets are continuously used. This not only reduces the cleaning efficiency of the spray nozzle, but also reduces the production efficiency. Furthermore, in the process of cleaning, scratches of the internal structure of the spray nozzle will be easily caused by the conventional thin film sheet, and the coating effect of the coater will be influenced.

### SUMMARY

With respect to the above technical problems present in the prior art, the present disclosure provides a thin film sheet and a preparation method thereof. By providing a gel layer, this thin film sheet increases the contact area with the spray nozzle and the cleaning effect for the spray nozzle of the coater has been also greatly improved. Meanwhile, scratches of the spray nozzle caused in cleaning are reduced. The use of the thin film sheet of this disclosure not only improves cleaning effect but also reduces the number of used thin film sheets required for cleaning, so as to save the production cost and increase the production efficiency.

The present disclosure provides a thin film sheet, which comprises a substrate and further comprises a gel layer formed on at least one side surface of the substrate, wherein the gel layer employs a swelling-type polymeric material. This thin film sheet can be used for cleaning a slit-type spray nozzle.

Preferably, the adhesion level between the gel layer and the substrate is international adhesion test standard level 0-2.

Preferably, the substrate is produced from any one material selected from polyurethane, polyethylene terephthalate, polybutylene terephthalate, polyamide, and polypropylene.

Preferably, the gel layer is obtained by swelling of a swelling-type polymer, and the swelling-type polymer is obtained by crosslinking and curing a gellant.

Preferably, the gellant is monomeric N-vinylpyrrolidone, and the gel layer is polyvinylpyrrolidone.

Preferably, the molecular weight of the polymer in the gel layer is in a range of 100 thousand to 500 thousand.

Preferably, the molecular weight of the polymer in the gel layer is in a range of 200 thousand to 300 thousand.

Preferably, the thickness of the gel layer is in a range of 20 μm-70 μm.

Preferably, the thickness of the gel layer is in a range of 30 μm-60 μm.

Preferably, the gel layer is provided on each surface of the substrate.

The disclosure also provides a preparation method of a thin film sheet, which comprises:

providing a substrate;

forming a gel layer on at least one surface of the substrate.

Preferably, the substrate is produced from any one material selected from polyurethane, polyethylene terephthalate, polybutylene terephthalate, polyamide, and polypropylene.

Preferably, the step of forming a gel layer on at least one surface of the substrate comprises:

soaking the substrate in a gellant;

heating the substrate soaked with the gellant, so that the gellant is crosslinked and cured and then forms a polymeric gel layer on a surface of the substrate; and

wetting the substrate with the polymeric gel layer in a solvent, so that the polymeric gel layer expands, so as to obtain the gel layer.

Preferably, the gellant is monomeric N-vinylpyrrolidone, and the gel layer is polyvinylpyrrolidone.

Preferably, the solvent is water, isopropanol, or ethanol.

Preferably, the duration for wetting the substrate with the polymeric gel layer in a solvent is in a range of 4-10 minutes.

Preferably, the duration for soaking the substrate in the gellant is in a range of 4-8 minutes, the temperature for heating the substrate soaked with the gellant is in a range of 40° C.-60° C., and the duration of heating is in a range of 10-15 minutes.

Preferably, the substrate is produced from a polyurethane material, and the production method thereof comprises:

heating and stirring a polyester polyol and an isocyanate under nitrogen atmosphere at 70-90° C. to produce a prepolymer, and adding about 1%-10% by mass of acetone based on the total mass of the polyester polyol and the isocyanate to reduce viscosity; then adding N-methyldiethanolamine for chain extension, and further adding 1%40% of acetone to reduce viscosity; and then adding dibutyltin dilaurate as a catalyst, dimethylolpropionic acid, and trimethylolpropane as a crosslinking agent, and performing reaction for 4-6 hours to prepare a polyurethane prepolymer; and

adding 1%-5% acetone in the polyurethane prepolymer for dilution, neutralizing with triethylamine, performing dispersion by adding deionized water under a stirring condition, and finally removing acetone by reduced-pressure distillation to prepare a polyurethane emulsion; and

thermocuring the polyurethane emulsion into a thin sheet, so as to produce a substrate.

In the thin film sheet of this disclosure, the contact area between the thin film sheet and the spray nozzle during cleaning has been increased by providing the gel layer; and furthermore, the cleaning effect for the spray nozzle of the coater has been thus greatly improved, since microporous structures of the surface of the gel layer can better adsorb dust on the spray nozzle of the coater. Meanwhile, the micro-elasticity of the gel layer can reduce scratches of the spray nozzle caused in cleaning. The use of the thin film sheet of this disclosure not only improves cleaning effect but also reduces the number of used thin film sheets during cleaning, so as to save the production cost, reduce the takt time of cleaning, and increase the production efficiency.

### BRIEF DESCRIPTION OF THE DRAWINGS

FIG. 1 is a sectional view of the structure of the thin film sheet in a preferred embodiment of this invention.

### DESCRIPTION OF EMBODIMENTS

In order to allow the person skilled in the art to understand the technical solution of this invention better, the thin film sheet and the preparation method thereof in this invention will be further described in detail in conjunction with accompanying drawings and specific embodiments.

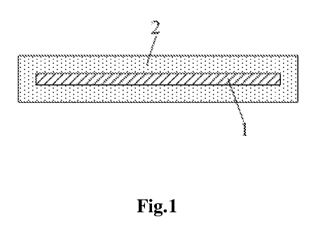

As shown in FIG. 1, a thin film sheet provided in a preferred embodiment of this invention comprises a substrate 1 and a gel layer 2 provided on at least one surface of the substrate 1, wherein the gel layer 2 is produced from a swelling-type polymeric material.

This thin film sheet is used for cleaning a slit-type spray nozzle of a coater. Here, the swelling-type polymeric material is prepared by expansion occurred after wetting the polymeric material in a solvent. The surface area of the swollen gel layer 2 is increased, and therefore, when the spray nozzle is being cleaned, the contact area between the gel layer 2 and the spray nozzle is increased. Therefore, when the spray nozzle is being cleaned, the number of used cleaning sheets is reduced, and in turn the cleaning cost is saved. Meanwhile, the takt time is also reduced, and the production efficiency is increased. Meanwhile, the swollen gel layer 2 has microporous structures and the microporous structures on the surface of the gel layer can adsorb residues in the spray nozzle, so that the cleaning effect for the spray nozzle of the coater is further increased. The microporous structures in the gel layer enable the gel layer to have a certain elasticity, which can prevent damage to the spray nozzle caused by the gel layer in the process of cleaning, so as to ensure the coating quality of the spray nozzle of the coater.

In this embodiment, the adhesion level between the gel layer and the substrate is international adhesion test standard level 0-2. This can ensure that the gel layer is substantially incapable of peeling off from the substrate in the process of cleaning the spray nozzle, so as to prevent contamination of the spray nozzle in the process of cleaning.

The test method of international adhesion test standard level is as follows. When a spray coated piece is used in an adhesion test, a crossed-grid pattern is cut on the coating layer with a scriber, and the cut extends to the base material; a brush is used to brush along the diagonal direction for five times, and an adhesive tape is pasted onto the cut and then peeled off; the condition of the zone of the grid is observed, and a magnifier can be used to observe the result of cross cut. The evaluation criteria of the level thereof is as follows. Level 0 of international adhesion test standard level requires that the edges of the cuts are fully smooth and there is no peeling at the edges of the grids; Level 1 of international adhesion test standard level requires that small pieces are peeled in intersected places of the cuts and the actual damage in cross-cut zones is not greater than 5%; Level 2 of international adhesion test standard level requires that there are peelings at the edges and/or the intersected places of the cuts, and the area thereof is greater than 5% but less than 15%.

The gel layer may be formed on each surface of the substrate. Such configuration is favorable to the cleaning of the spray nozzle with the thin film sheet of this disclosure at different angles or in different directions. Since the gel layer 2 has elasticity, damage to the spray nozzle will not be caused in the process of cleaning, and cleaning efficiency is increased. Of course, the gel layer may also be formed on a part of the side surfaces of the substrate, for example formed on two side surfaces of the substrate, which have relatively large areas.

The substrate 1 may comprise any one material among polyurethane, polyethylene terephthalate, polybutylene terephthalate, polyamide, and polypropylene. The gel layer is produced by swelling of a polymer, which is obtained by crosslinking and curing a gellant.

Here, the molecular weight of the polymer in the gel layer is in a range of 100 thousand to 500 thousand. Preferably, the molecular weight of the polymer in the gel layer is in a range of 200 thousand to 300 thousand.

The gellant may be monomeric N-vinylpyrrolidone, and the gel layer is polyvinylpyrrolidone. Polyvinyl pyrrolidone is a polymeric swelling-type material. After polyvinylpyrrolidone is wetted with a solvent, molecules of the solvent can rapidly enter the polymeric polyvinylpyrrolidone, so that the expansion of polyvinylpyrrolidone occurs. The swollen high-molecular polymer increases the contact area with the spray nozzle during cleaning and is allowed to clean the spray nozzle more thoroughly. The swollen high-molecular polymer has microporous structures. Such microporous structures have a certain adsorption force for foreign matters such as dust, etc., in the spray nozzle, and can effectively remove residues remaining in the spray nozzle. The swollen high-molecular polymer has elasticity and is allowed to prevent damage to the interior of the spray nozzle in the process of cleaning, so as to elongate the useful life of the spray nozzle. By using the polymeric swelling-type material having the advantages described above, the number of cleaning sheets required when cleaning the spray nozzle is reduced, and the production efficiency is increased while the cost is reduced.

In this embodiment, the thickness of the gel layer is in a range of 20 μm-70 μm. Preferably, the thickness of the gel layer is in a range of 30 μm-60 μm. The gel layer having said thickness can favorably enter and exit the interior of the slit-type spray nozzle, and also can clean residues in the spray nozzle well.

In another embodiment of this invention, there is provided a preparation method of the thin film sheet described above, which comprises:

Step 1: providing a substrate.

The substrate may be produced from any one material of polyurethane, polyethylene terephthalate, polybutylene terephthalate, polyamide, and polypropylene.

By exemplifying a polyurethane material, the process for producing the substrate is as follows. A polyester polyol such as a polyester diol and an isocyanate heated and stirred under nitrogen atmosphere at 70-90° C. to produce a prepolymer, an appropriate amount (1%-10%) of acetone is added to reduce viscosity. N-methyldiethanolamine is added for chain extension, and acetone (1%-10%) is further added to reduce viscosity. Dibutyltin dilaurate as a catalyst, dimethylolpropionic acid, and trimethylolpropane as a crosslinking agent are added in appropriate amounts, and the reaction is performed for 4-6 hours to prepare a polyurethane (PU) prepolymer. A small amount (1%-5%) of acetone is added for dilution, triethylamine is used for neutralization, dispersion is performed by adding deionized water with rapid stirring, and acetone is finally removed by reduced-pressure distillation, to obtain a polyurethane emulsion. In a glassware, the polyurethane emulsion is thermocured into a thin sheet, and thereby a substrate is obtained.

The substrate may be prepared from other materials according to other methods known in the prior art, and it is not limited in this invention.

Step 2: forming a gel layer on at least one side surface of the substrate.

This step specifically comprises the steps as follows.

Step 2-1: soaking the substrate prepared in Step 1 in a gellant.

The gellant is monomeric N-vinylpyrrolidone, and the substrate in Step 1 may be placed in analytically pure vinylpyrrolidone. The duration for soaking the substrate in the gellant is in a range of 4-8 minutes.

Step 2-2: heating the substrate soaked with the gellant, so that the gellant is crosslinked and cured and forms a polymeric gel layer on the surface of the substrate.

In this step, the temperature for heating is in a range of 50° C.−100° C., and the duration of heating is in a range of 10-15 minutes. In the process of heating, the crosslinking reaction of the gellant occurs, so as to form a polymeric gel layer comprising polyvinylpyrrolidone on the surface of the substrate.

Step 2-3: wetting at least a part of the substrate with a polymeric gel layer in a solvent, so that the polymeric gel layer expands, to obtain a swollen gel layer.

In this step, the solvent is any one of water, isopropanol, and ethanol. These solvents may permeate into the molecular structure of the polymeric gel layer. The duration for wetting the substrate with the polymeric gel layer in a solvent is in a range of 1-10 minutes, preferably 3-10 minutes, more preferably 4-8 minutes. Since the difference in molecular size of the high-molecular polymeric gel layer and that of the solvent molecule is remarkable, the solvent molecule can rapidly enter the polymeric gel layer and allow the expansion of the polymeric gel layer, so as to form a swollen gel layer.

Furthermore, in the process of wetting, at least four fifths of the length of the substrate having the polymeric gel layer may be soaked into a vessel containing a solvent, and then residues in the spray nozzle may be cleaned with the soaked part.

### EXAMPLES

### Example 1

A substrate produced from a polyurethane material was soaked in analytically pure N-vinylpyrrolidone for 4 minutes, and then heated at 70° C. temperature for 8 minutes, so as to form a polyvinylpyrrolidone gel layer on the substrate, and the substrate having the gel layer was placed in isopropanol for wetting for 2 minutes to obtain a thin film sheet A of this disclosure.

### Examples 2-9

Thin film sheets B-I of this invention were prepared according to the method of Example 1, except specific conditions as can be seen in Table 1.

TABLE 1

| | Thermocuring time | | |
|---|---|---|---|
| | thermocuring | thermocuring | thermocuring |
| Soaking time | for 8 min. | for 10 min. | for 12 min. |
| Soaking time | Processing type | | |
| soaking for 4 min. | A | B | C |
| soaking for 6 min. | D | E | F |
| soaking for 8 min. | G | H | I |

Spray nozzles for coating were respectively cleaned with a polyurethane substrate and the thin film sheets A-I of this disclosure, and the number of used cleaning sheets and the cleaning effect can be seen in Table 2.

TABLE 2

| | | Determination |
|---|---|---|
| | | whether being |
| | Number of sheets | superior to |
| Processing type | required for cleaning | conventional sheet |
| Conventional | 4 | — |
| processing sheet | | |
| A | 4 | NO |
| B | 4 | NO |
| C | 3 | OK |
| D | 4 | NO |
| E | 4 | NO |
| F | 3 | OK |
| G | 4 | NO |
| H | 3 | OK |
| I | 2 | OK |

It can be seen from the results of Table 2 that the number of used thin film sheets of this disclosure has been remarkably reduced, so as to save the cost and increase the production efficiency.

It can be understood that the above embodiments are merely exemplary embodiments used for illustrating the principle of this invention. However, this invention is not limited thereto. With respect to those of ordinary skill in the art, various variations and modifications can be made without departing from the spirit and the substance of this invention. These variations and modifications are also considered as the scope protected by this invention.

1. A thin film sheet, comprising a substrate and a gel layer located on at least one surface of the substrate, wherein the gel layer is produced from a swelling-type polymeric material, and
wherein the gel layer is obtained by swelling of a swelling-type polymer, and the swelling-type polymer is obtained by crosslinking and curing a gellant.

2. The thin film sheet according to claim 1, wherein the adhesion level between the gel layer and the substrate is international adhesion test standard level 0-2.

3. The thin film sheet according to claim 1, wherein the substrate is produced from any one or more materials selected from polyurethane, polyethylene terephthalate, polybutylene terephthalate, polyamide, and polypropylene.

4. (canceled)

5. The thin film sheet according to claim 1, wherein the gellant is monomeric N-vinylpyrrolidone, and the swelling-type polymer in the gel layer is crosslinked polyvinylpyrrolidone.

6. The thin film sheet according to claim 5, wherein the molecular weight of the swelling-type polymer in the gel layer is in a range of 100 thousand to 500 thousand.

7. The thin film sheet according to claim 5, wherein the molecular weight of the swelling-type polymer in the gel layer is in a range of 200 thousand to 300 thousand.

8. The thin film sheet according to claim 1, wherein the thickness of the gel layer is in a range of 20 μm-70 μm.

9. The thin film sheet according to claim 1, wherein the thickness of the gel layer is in a range of 30 μm-60 μm.

10. The thin film sheet according to claim 1, wherein the gel layer is provided on each surface of the substrate.

11. A preparation method of the thin film sheet according to claim 1, wherein the preparation method comprises:
providing a substrate; and
forming a gel layer on at least one surface of the substrate,
wherein the process of forming the gel layer on at least one surface of the substrate comprises:
soaking the substrate in a gallant;
heating the substrate soaked with the gallant, so that the gallant is crosslinked and cured and then forms a swelling-type polymer layer on a surface of the substrate; and
wetting the substrate with the swelling-type polymer layer in a solvent, so that the swelling-type polymer layer expands, so as to obtain the gel layer.

12. The preparation method according to claim 11, wherein the substrate is produced from any one material selected from polyurethane, polyethylene terephthalate, polybutylene terephthalate, polyamide, and polypropylene.

13. (canceled)

14. The preparation method according to claim 11, the gellant is monomeric N-vinylpyrrolidone, and the swelling-type polymer in the gel layer is crosslinked polyvinylpyrrolidone.

15. The preparation method according to claim 11, wherein the solvent is water, isopropanol, or ethanol.

16. The preparation method according to claim 11, wherein the duration for wetting the substrate with the swelling-type polymer layer in a solvent is in a range of 4-10 minutes.

17. The preparation method according to claim 11, wherein the duration for soaking the substrate in the gellant is in a range of 4-8 minutes, the temperature for heating the substrate soaked with the gellant is in a range of 40° C.−60° C., and the duration of heating is in a range of 10-15 minutes.

18. The preparation method according to claim 12, wherein the substrate is produced from a polyurethane material, and the production method thereof comprises:
heating and stirring a polyester polyol and an isocyanate under nitrogen atmosphere at 70-90° C. to produce a prepolymer, and adding 1%-10% of acetone to reduce viscosity; then adding N-methyldiethanolamine for chain extension, and further adding 1%40% of acetone to reduce viscosity; and then adding dibutyltin dilaurate as a catalyst, dimethylolpropionic acid, and trimethylolpropane as a crosslinking agent, and performing reaction for 4-6 hours to prepare a polyurethane prepolymer; and
adding 1%-5% acetone in the polyurethane prepolymer for dilution, neutralizing with triethylamine, performing dispersion by adding deionized water under a stirring condition, and finally removing acetone by reduced-pressure distillation to prepare a polyurethane emulsion; and
thermocuring the polyurethane emulsion into a thin sheet, so as to produce a substrate.

19. The thin film sheet according to claim 1, wherein the crosslinking and curing is crosslinking and curing by heat.

20. A method for cleaning a spray nozzle of a coater by using the thin film sheet according to claim 1, comprising bringing the gel layer of the thin film sheet into contact with a site to be cleaned.
